(19) United States
(12) Patent Application Publication
(10) Pub. No.: US 2025/0290736 A1
(43) Pub. Date: Sep. 18, 2025

(54) MEASURING TAPE CLIP

(71) Applicants: Andreas HAASE, Palm Bay, FL (US); Mike SCHULTZ, Palm Bay, FL (US)

(72) Inventors: Andreas HAASE, Palm Bay, FL (US); Mike SCHULTZ, Palm Bay, FL (US)

(21) Appl. No.: 19/078,719

(22) Filed: Mar. 13, 2025

Related U.S. Application Data
(60) Provisional application No. 63/564,559, filed on Mar. 13, 2024.

(51) Int. Cl. G01B 3/1071; G01B 5/00

(52) U.S. Cl. CPC G01B 3/1071; G01B 5/0004; G01B 2003/1074; G01B 2003/1076

(57) ABSTRACT

A clip for measuring a distance between a first object and a second object with a measuring tape. The clip includes first and second opposing parallel sidewall surfaces and a third wall surface that connects the first and second sidewall surfaces so as to form an inverted U-shape. The clip further includes an affordance (for example a slot) on one or both of the first and second sidewall surfaces for receiving a hook-end of the measuring tape. A distance between the first and second sidewall surfaces is dimensioned to allow the clip to be removably mounted on an object. And this distance is variable due to the expandable material of the third wall surface.

### CROSS REFERENCE TO RELATED APPLICATIONS

The present application claims priority to the provisional application filed on Mar. 13, 2024 and assigned application No. 63/564,559 (Attorney Docket 16850-002), which is incorporated herein in its entirety

### FIELD OF THE INVENTION

An apparatus for clamping a measuring tape to a fixed building/construction object to measure an distance between two building/construction objects, e.g., an inside distance. Absent the clip of the present invention, to measure such long distances requires a first person to hold a first end of the measuring tape against the first building/construction object and a second person to hold a far end of the measuring tape against the second building/construction object. This apparatus also decreases the opportunity for measurement mistakes when utilizing fractional increments.

### BACKGROUND OF THE INVENTION

The present invention includes certain features shared by a spring steel binder clip. The binder clip was invented, and patented in 1910 by Washington, D.C. area resident Louis E. Baltzley, grandson of Elias Howe, to more easily hold his father's manuscripts. While similar-purposed designs have since been patented, the most produced version remains as descried in U.S. Pat. No. 1,139,627.

Currently, there is no apparatus that allows a builder/contractor to hold a measuring tape against a 2×4 board or a mortar block, for example, and measure the distance to an opposing wall or board, without the assistance of a helper to hold one end of the measuring tape against the opposing wall or board. These current techniques increase labor costs or if done by a single person alone invite more opportunities for measuring errors, thereby compromising blueprint directives.

### SUMMARY OF THE INVENTION

The objective of this invention is to simplify the measuring process when utilizing a tape measure when only one person is present to measure a long distance, that is, a distance longer than the span of a person's arms.

The inventive object comprises a clip that is temporarily attached to a first fixed object, such as a 2×4 or a mortar block. A measuring tape is removably secured to the clip and extended by a worker to the second object where the distance is read from the measuring tape.

This inventive clip is portable and easy to use by a builder/contractor, especially when a second person is not available to assist with a measuring operation. Also, the clip is easily attached to and removed from the fixed object after the distance has been measured.

There are multiple embodiments of the present invention that solve the described problem. One embodiment comprises a single-piece spring steel clip that incorporates a slot for receiving the tab or hook end of a measuring tape.

Another version comprises two injection molded parts and a single piece of spring steel bent to fit the current standard of 2×4's and mortar blocks.

### BRIEF DESCRIPTION OF THE FIGURES

FIG. 1 illustrates s first embodiment of a measuring tape clip of the present invention.

FIG. 2 illustrates a clip of the present invention mounted on a 2×4 for use in measuring a distance from the illustrated 2×4 to another object.

FIG. 3 illustrates a clip of the present invention removably attached to a tape measure for storage or for carrying.

FIG. 4 illustrates a cross-sectional view taken along line 44 of FIG. 1.

FIG. 5 illustrates a second embodiment of the present invention.

FIG. 6 illustrates a third embodiment of the present invention.

### DETAILED DESCRIPTION OF THE INVENTION

Unless defined otherwise, all technical and scientific terms used herein have the same meaning as commonly understood by one of ordinary skill in the art to which this invention pertains. Although any methods and materials similar or equivalent to those described herein can be used in the practice or testing of the invention, the preferred methods and materials are now described. All publications mentioned herein are incorporated herein by reference.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Reference throughout this specification to “one embodiment”, “an embodiment,” “an example embodiment,” means that a particular feature, structure, or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may. Furthermore, the particular features, structures, or characteristics may be combined in any suitable manner, as would be apparent to a person skilled in the art of this disclosure, in one or more embodiments. Furthermore, while some embodiments described herein include some, but not other features included in other embodiments, combinations of features of different embodiments are meant to be within the scope of the invention. For example, in the appended claims, any of the claimed embodiments can be used in any combination.

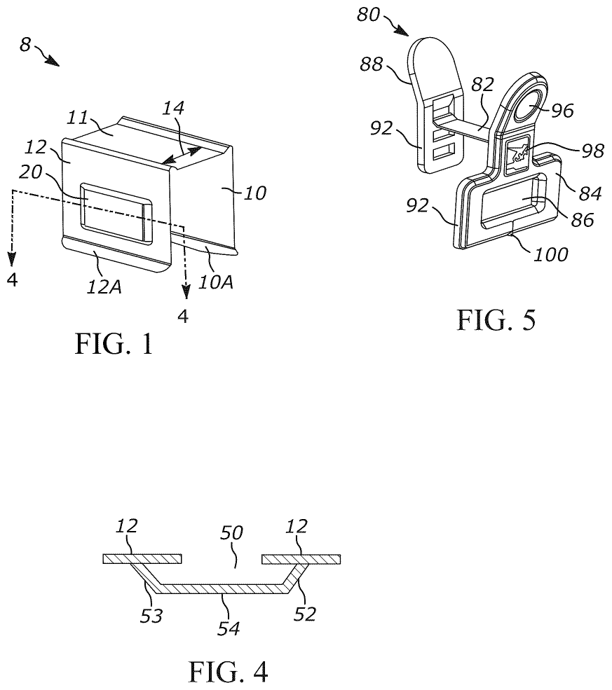

In a first embodiment (see FIG. 1) a clip 8 comprises two substantially parallel sidewall surfaces 10 and 12 and a connecting top surface 11. As can be seen, the three surfaces are joined to form an inverted U with the sidewall surfaces 10 and 12 forming an approximate 90 degrees angle with the connecting top surface 11. The sidewall surfaces 10 and 12 are also referred to as a front sidewall surface 12 and a rear sidewall surface 10.

The clip further defines a bent lip or feature 12A on the surface 12 and a bent lip or feature 10A on the surface 10. These bent lips 10A and 12A allow the clip to be easily engaged with a building material object, e.g., with a 2×4 board or a concrete block. However, as those skilled in the art are aware, the nominal dimensions of a 2×4 board are 2 inches thick by 4 inches wide, but the actual dimensions are 1.5 inches thick by 3.5 inches wide.

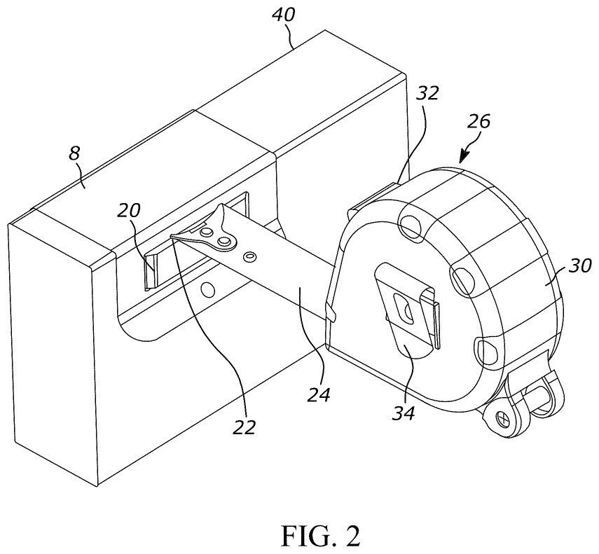

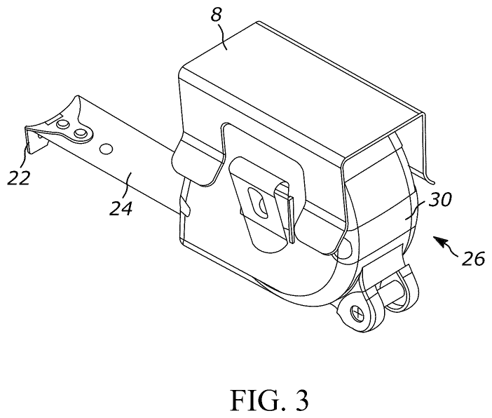

The clip also defines an affordance 20 (a slot in one embodiment) for receiving a hook 22 disposed at the end of a coilable measuring tape or blade 24 of a tape measure 26. The hook 22 is only partially visible in FIG. 2 and fully visible in FIG. 3.

A width of the top surface 11, as indicated by a reference numeral 14, is variable to accommodate various dimensions of a objects associated with the measuring operation. For example, the top surface 11 can be dimensioned to engage the shorter dimension of a 2×4 board then expanded to engage the greater width dimension of a concrete block. Materials with dimension variability include, expandable materials based on a slit and stretch expansion process, perforated materials, wire mesh, and woven products. The top surface can be comprises of any of these materials.

As further illustrated in FIG. 2, the tape measure 26 comprises an enclosure 30 that defines an internal chamber (not shown) that houses the coiled portion of the tape or blade 24, a suitable tape-biasing device (e.g., retraction spring not shown), and a portion of the measuring tape or blade locking mechanism 32. The enclosure 30 includes an opening (not visible in FIGS. 3 and 4) defined in a front surface through which the tape or blade 24 passes as extended from a coiled configuration within the enclosure 30. A belt clip 34 may be attached to a side surface of the enclosure 30.

Returning to FIGS. 1 and 2, the affordance 20 comprises one or more elements for receiving and securely holding such a hook, tab, or loop during a measuring operation.

FIG. 4 is a cross-sectional view along line AA in FIG. 1. The affordance, opening, or slot 20 is defined in a plane of the sidewall surface 12 (see FIG. 1) and protruding wall elements 52 and 53 extend outwardly from the sidewall surface. A connecting wall element 54 is connected to both protruding wall elements. The elements 52, 53, and 54 define the opening or slot 50 into which a hook of a tape measure is placed during a measuring operation.

Returning to FIG. 2, when it is desired to measure a distance between two objects, a user removably attaches the clip 8 to a first object, such as a 2×4 40 and removably attaches a measuring tape hook 22 to the clip affordance 20 (that is, within the slot). The user then extends the measuring tape 24 to a second object, and reads the distance between the first and second objects from the extended measuring tape.

Preferably, a material of the clip 8 comprises spring steel to securely hold the clip to the first object during the measuring operation, while allowing easy removal of the clip after the measuring operation has been completed. As illustrated in FIG. 2, the spring steel material urges the clip against the board 40 (that is, inwardly directed forces exerted by the sidewall surfaces 10 and 12) to ensure the clip does not disengage from the first object during the measuring operation. Generally, spring steel includes the advantageous properties of elasticity (that is, spring steel can be bent or stretched and then return to its original shape), strength (that is, spring steel can support heavy loads without breaking), and resilience (that is, spring steel can withstand cyclical loads that would fatigue other steel alloys). Typically, the spring steel comprises a low-alloy manganese, medium-carbon steel, or high-carbon steel. The steel is processed by cold drawing, cold rolling, or heat treating.

The clip of the present invention is especially useful at a construction site where a single worker can easily measure distance between objects that might otherwise require two workers. In particular, to measure the inside distance between two distant 2×4 studs, the worker attaches the clip to one 2×4 stud and proceeds to make the measurement as described above.

The clip described herein is a consumer entry-level item that is manufactured from spring steel and decorated in a variety of finishes, such as chrome, powder coated, hydro-dipped, and using other decorative processes.

Another embodiment (see FIG. 5) comprises a clip 80 further comprising a plurality of elements that are designed to hold onto a 2×4 or a brick or block. The main components comprise a spring steel piece 82, a front component 84 that includes an affordance 86 to accept and securely hold a variety of measuring tape sizes and styles, and a rear component 88. The front and rear surfaces are urged by forces exerted by the spring steel piece 82 against opposing surfaces of a building material or object.

In one embodiment, the front surface 84 and the rear surface 88 are formed by injection molding.

In one embodiment, soft grip materials are disposed on edge surfaces 92 of the front and rear surfaces 84 and 88. These surfaces provide a comfortable grip for the clip 80.

A decorative plate 96 may be applied (e.g., using an adhesive, mechanically applied) to cover some of the molding features on both the front and rear surfaces when injection molded, as these features would otherwise detract from the overall appearance of the clip 80.

The front surface 84 also includes a region 98 for placement of a logo and/or brand name.

Additionally, there is an in-molded vertical line 100 to facilitate accurate measuring at a specific location.

In one embodiment, the three-piece clip 80 comprises a spring steel main component 82 and injection molded parts that are mechanically affixed to the spring steel component. The injection molded parts are preferably molded in a durable and rugged high visibility color that is easy to locate.

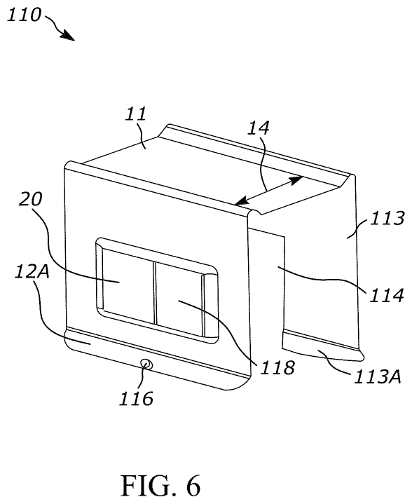

Yet another embodiment of a clip 110 is illustrated in FIG. 6, wherein a region of a rear sidewall surface 113 (and a bent lip 113A) has been removed, as illustrated, thereby creating an opening 114.

Another opening 116 is defined in the bent lip 12A for receiving a fastener (e.g., a nail or screw) for affixing the clip to an object during a measuring operation.

The clip 110 further comprises a vertical line or mark 118 to facilitate accurate placement of the measuring tape within the affordance 20.

What is claimed is:

1. A clip for use in measuring a distance between a first object and a second object with a measuring tape, the clip comprising:
first and second opposing parallel sidewall surfaces;
a third wall surface connecting the first and second sidewall surfaces so as to form an inverted U-shape;
an affordance on one or both of the first and second sidewall surfaces for receiving a terminal end of the measuring tape for use in measuring the distance between the first and second objects;
wherein a distance between the first and second sidewall surfaces is dimensioned to allow the clip to be removably mounted on the first object.

2. The clip of claim 1, wherein the first object comprises a board having nominal dimensions of 2 inches thick by 4 inch wide, the clip for removably mounting on the 2 inches thick surface.

3. The clip of claim 1, wherein the measuring tape comprises a retractable measuring tape.

4. The clip of claim 1, wherein a material of the first and second sidewall surfaces comprises spring steel for retaining the clip on the first object during a measuring operation, such that when mounted on the first object the first and second sidewall surfaces are in contact with opposing surfaces of the first object and exert an inwardly directed force against the opposing surfaces of the first object for retaining the clip on the first object.

5. The clip of claim 1, wherein the distance between the first and second sidewall surfaces allows the clip to be removably attached to a measuring tape enclosure

6. The clip of claim 1, further defining a circular opening in one of the first and second sidewall surfaces for receiving a fastener for removably affixing the clip to the first object.

7. The clip of claim 1, further comprising soft surfaces on edges of the first and second sidewall surfaces and the third wall surface.

8. The clip of claim 1, wherein the affordance is configured for receiving a measuring tape hook disposed at a terminal end of the measuring tape.

9. The clip of claim 1, wherein placement of the clip on the first object with the affordance oriented on a surface of the first object facing the second object, for measuring an inside dimension between the first and second objects.

10. The clip of claim 1, wherein the affordance comprises a slot for receiving a terminal end of the measuring tape, wherein the terminal end of the measuring tape further comprises a hook.

11. The clip of claim 1, wherein the clip is configured on the first or the second object for measuring an inside distance between the first and second objects.

12. The clip of claim 1, wherein the clip is configured on the first or the second object to measure a distance between a first surface of the first object and a first surface of the second object, wherein the first surface of the first object and the first surface of the second object are oriented to face each other.

13. The clip of claim 1, wherein a width of the third wall surface between the first and second sidewall surfaces is variable for accommodating differently sized first objects.

14. A clip comprising first and second components connected by a spring steel component, wherein a distance between the first and second components is dimensioned to allow the clip to be removably mounted on a first object, the clip further comprising an affordance on the first component, the affordance shaped and sized for receiving a terminal end of a measuring tape for use in measuring a distance between the first object and a second object.

15. The clip of claim 14, further comprising a centerline mark proximate the affordance for aligning placement of the terminal end of the measuring tape.
